(19) United States
(12) Patent Application Publication
(10) Pub. No.: US 2019/0289822 A1
(43) Pub. Date: Sep. 26, 2019

(54) Device to Device Communication

(71) Applicants: Erick Eidus, Kirkland, WA (US); Kandarp Jani, Bellevue, WA (US)

(72) Inventors: Erick Eidus, Kirkland, WA (US); Kandarp Jani, Bellevue, WA (US)

(21) Appl. No.: 16/248,697

(22) Filed: Jan. 15, 2019

Related U.S. Application Data
(63) Continuation of application No. 14/815,897, filed on Jul. 31, 2015.

(51) Int. Cl. A01K 15/02; A01K 29/00

(52) U.S. Cl. CPC A01K 15/021; A01K 15/025; A01K 29/005

(57) ABSTRACT

An adaptive learning system for animals may allow pets to engage in games, exercises, training, and other activities with little to no human oversight. A pet may initiate game play by triggering a motion sensor or visual detection sensor, for example, and may progress through levels based on its completion of tasks. An adaptive learning system for animals may include communications hardware, either wired or wireless, that may link multiple devices together and allow for direct communication between the devices.

### RELATED APPLICATIONS

This application claims priority to and is a continuation of U.S. patent application Ser. No. 14/815,897, entitled “Adaptive Learning Systems for Animals,” filed on Jul. 31, 2015, the contents of which are incorporated by reference herein in their entirety.

### FIELD

This disclosure relates generally to Adaptive Learning System for Animals.

### BACKGROUND

Many people want to build strong, lasting relationships with their pets. Unfortunately, many owners don't have much time to be physically present with their pets because of time spent away at school or work, for example. However, many owners want their pets to develop cognitive, behavioral, and social skills to become healthy, disciplined, and confident animals, for example. Conventional pet games and training products require a significant amount of human oversight and don't facilitate the independent learning and development of pets.

### SUMMARY

The following presents a simplified summary of the disclosure to provide a basic understanding to the reader. This summary is not an extensive overview of the disclosure, nor does it identify key or critical elements of the claimed subject matter or define its scope. Its sole purpose is to present some concepts disclosed in a simplified form as a precursor to the more detailed description that is later presented.

The instant application discloses, among other things, Adaptive Learning System for Animals. In one embodiment, it may comprise a gaming system which may allow pets to engage in games, exercises, training, and other activities with little to no human oversight. A pet may initiate game play by performing an action such as pressing a button, touching a toy, picking up a toy, or triggering a motion sensor or visual detection sensor, for example. Game play may also be initiated automatically based on time or a system event, or it may be initiated remotely, for example, by a human using a computer user interface, browser or mobile application. A pet may progress through stages of a game based on its successful completion of various tasks. Adaptive Learning System for Animals may direct a pet to repeat a task or stage if the pet fails or struggles to complete a task, for example. Adaptive Learning System for Animals may recommend, personalize, and modify games based on the age, breed, personality, or other characteristics of a pet.

Adaptive Learning System for Animals may include a console that is physically separate from and compatible with third-party products such as game controllers, pet toys, and reward dispensing units, for example. Humans may also initiate a pet's game play, record and watch game play, and otherwise participate remotely through a computer or mobile device, for example. Humans may receive notifications about a pet's progress through messages, email, photos, video clips, and other multimedia formats, and data may be shared through social media and other outlets.

Adaptive Learning System for Animals may further include communications hardware, either wired or wireless, that may link multiple devices together and allow for direct communication between the devices. For example, game controllers, pet toys, and reward dispensing units may be connected by the communication hardware to facilitate direct communication between one or more of the devices.

Adaptive Learning System for Animals may use operant conditioning, whereby a pet may learn to associate a given voluntary behavior with a given consequence. For operant conditioning to be successful, the timing of the association between the voluntary behavior and the given consequence may be critical. Human involvement typically produces delays and judgment, thereby reducing conditioning success. Adaptive Learning System for Animals may reduce the timing to milliseconds and remove human judgment. The use of operant conditioning may also give the pet an intuitive user experience.

Many of the attendant features may be more readily appreciated as they become better understood by reference to the following detailed description considered in connection with the attached drawings.

### BRIEF DESCRIPTION OF THE DRAWINGS

FIG. 1 illustrates an Adaptive Learning System for Animals system, according to one embodiment.

FIG. 2 illustrates a flow diagram of an Adaptive Learning System for Animals process, according to one embodiment.

FIG. 3 illustrates a flow diagram of an Adaptive Learning System for Animals herding game process, according to one embodiment.

FIG. 4 is a block diagram illustrating an example of a system capable of supporting an Adaptive Learning System for Animals, according to one embodiment.

FIG. 5 illustrates an Adaptive Learning System for Animals system, according to another embodiment.

FIG. 6 illustrates Adaptive Learning System for Animals, according to another embodiment.

FIG. 7 illustrates Adaptive Learning System for Animals, according to another embodiment.

FIG. 8 illustrates Adaptive Learning System for Animals, according to another embodiment.

FIG. 9 illustrates Adaptive Learning System for Animals, according to another embodiment.

FIG. 10 illustrates a flow diagram of Adaptive Learning System for Animals, according to another embodiment.

FIG. 11 is a component diagram of a computing device to which an Adaptive Learning System for Animals may be applied according to one embodiment.

Like reference numerals are used to designate like parts in the accompanying drawings.

### DETAILED DESCRIPTION

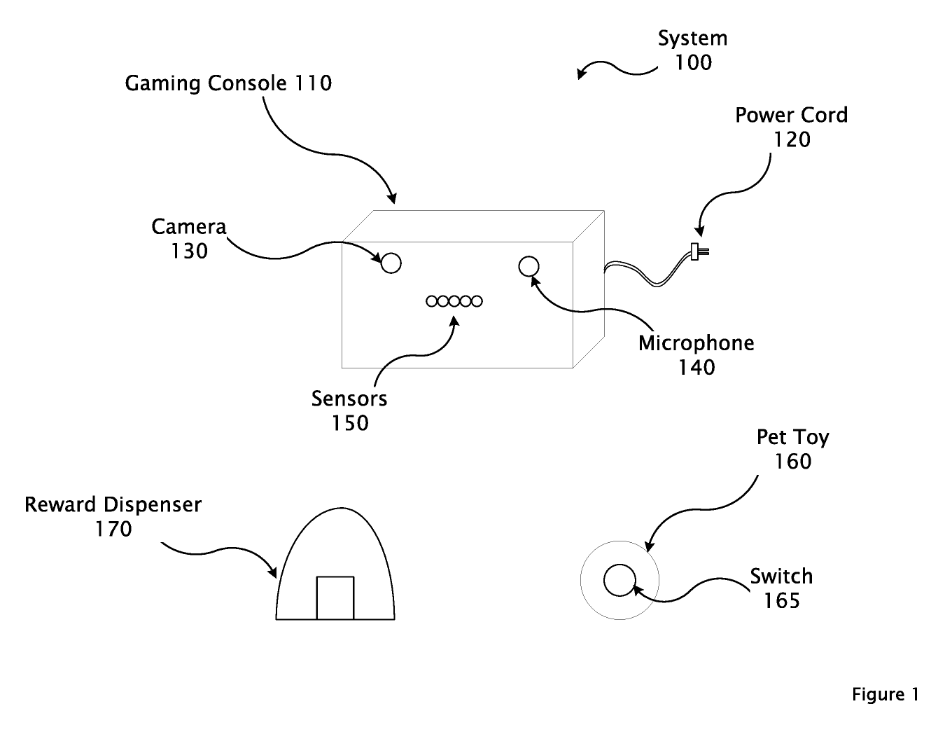

FIG. 1 illustrates Adaptive Learning System for Animals 100 according to one embodiment. In this example, Adaptive Learning System for Animals 100 may comprise a gaming system which allows pets to engage in games, exercises, training, and other activities with little to no human oversight. Gaming Console 110 may comprise a controlling unit with one or more interfaces, for example, a BLUETOOTH® Low Energy (BLE) interface, a Wi-Fi interface, and a radio frequency (RF) interface. Gaming Console 110 may receive power through an electronic Power Cord 120, for example, or other means. One having skill in the art will recognize that other power sources, such as batteries, may be used. Gaming Console 110 may include lights to indicate status, for example. Gaming Console 110 may include or couple to a Camera 130, which may capture still images, video images, infrared heat signatures, and other data. Gaming Console 110 may include or couple to a Microphone 140, which may detect sounds which may be used to distinguish whether a pet has initiated game play or to identify or distinguish a pet, for example. Gaming Console 110 may also include or couple to a plurality of Sensors 150, including, for example, an accelerometer, a proximity sensor, a motion sensor, a touch sensor, a pressure sensor, or a biometric sensor. One having skill in the art will recognize that other sensors may be used. A biometric sensor may measure and analyze physical characteristics of a pet; for example, it may recognize a dog by size or color. The biometric sensor may also recognize facial patterns (facial recognition), voice patterns, retina or iris patterns, paw prints, or DNA, for example, for authentication purposes or to personalize game play, for example. Gaming Console 110 may be physically separate from and compatible with various third-party products such as game controllers, pet toys, and reward dispensing units, for example.

Gaming Console 110 may communicate with Pet Toy 160. Pet Toy 160 may include a plurality of electronics such as a camera, microphone, speakers, lights such as light-emitting diodes (LEDs), and sensors such as an inductance sensor, accelerometer, motion detection sensor, proximity sensor, touch sensor, moisture sensor, radio-frequency identification (RFID), and a physical switch to detect a moving part, for example. Adaptive Learning System for Animals 100 may include an actuator or other mechanical components which may allow the toy to move, vibrate, or generate a sound. Adaptive Learning System for Animals 100 may also include near-field communication (NFC) technology for functions such as tracking the location of items, for example. One having skill in the art will recognize that other sensors may be used. Pet Toy 160 may be a hard or soft toy, for example, and may be configured to protect the internal electronics from damage, and to protect a pet from injury from tampering or ingesting Pet Toy 160 or its components. A human may receive a notification when Pet Toy 160 has been damaged or otherwise compromised and may automatically receive a new toy in the mail. Adaptive Learning System for Animals may allow a pet to charge a toy on its own by performing an action such as placing the toy on a wireless charging mat, for example. Pet Toy 160 may also report its battery level to Gaming Console 110, which may communicate the battery level to a human.

Adaptive Learning System for Animals 100 may detect a pet's actions or lack of actions. For example, a sensor may not detect an expected action, and the lack of action may also have an impact on the state of the system. There may be situations wherein the sensors detect an action at the wrong time or at a time that is not intended. This may also have an impact on the state of the system. For example, touching a toy (for example, moving an accelerometer) when a toy is not supposed to be touched, may delay a pet's ability to earn a reward.

Upon the completion of certain actions or lack of actions, a pet may receive rewards from Reward Dispenser 170, which may be any third-party dispenser, for example. Reward Dispenser 170 may dispense food, toys, smells, sounds, images, and tactile sensations, or other rewards, for example. Smells may be dispensed in the form of liquids, gasses, or bubbles, for example, and tactile sensations may include, for example, petting and massages. Rewards may be dispensed automatically, without any human intervention, or they may be dispensed with human intervention; for example, by the pressing of a remote-control button.

Adaptive Learning System for Animals 100 may include a Switch 165, such as a large button, which a pet may touch to turn on a device such as Toy 160. In this example, Switch 165 may need to be held down for several seconds to turn off Toy 160, for example, five seconds, but may be briefly touched to turn Toy 160 on. This may allow a human to turn off the device but to prevent a pet from turning it off by accident, for example. Switch 165 configuration may be controlled by software.

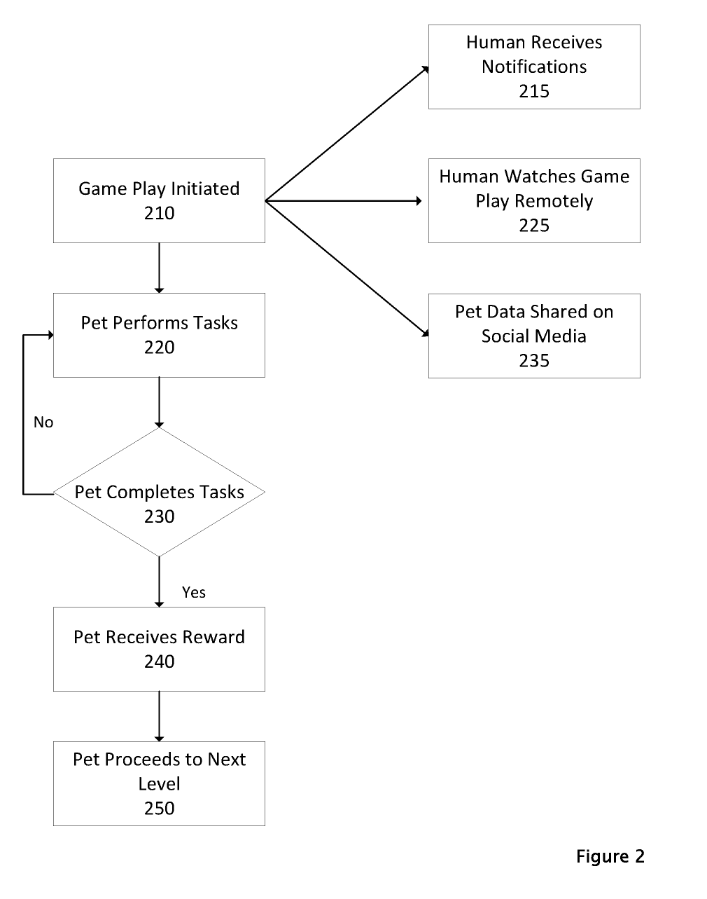

FIG. 2 illustrates a flow diagram of an Adaptive Learning System for Animals process, according to one embodiment. At Game Play Initiated 210, a pet may initiate game play by performing an action such as pressing a button, picking up a toy, or triggering a motion sensor or visual detection sensor, for example. Game play may also be initiated automatically based on time or a system event, or it may be initiated remotely, for example, by a human using a computer user interface, browser or mobile application. At Pet Performs Tasks 220, the pet may progress through game levels based on completion of various tasks. If Pet Completes Tasks 230, the pet may move on to Pet Receives Reward 240. The pet may complete a task and receive rewards many times before moving on to another level. At any stage during an Adaptive Learning System for Animals process, a software program may determine whether the pet has successfully completed a task and whether it should proceed to a different level based on past performance, for example. A human may also send commands to Gaming Console 110 to influence which task the pet has to complete. If the task is not complete at Pet Completes Tasks 230, the pet may be redirected back to Pet Performs Tasks 220. The pet may be directed to a previous level if it fails to complete certain tasks if Adaptive Learning System for Animals system 100 has determined that a pet is struggling at a task or level, for example. A pet may also be directed to jump or skip to higher levels. At Pet Proceeds to Next Level 250, the pet may begin a new level, which may include more advanced or challenging tasks, or simply a different task which is not necessarily more challenging, for example. The pet may receive additional rewards for completing a level, or it may receive rewards only upon completing all levels in a game, for example. Adaptive Learning System for Animals 100 may recommend, personalize, and modify games based on the age, breed, personality, and other characteristics of a pet.

In one embodiment, a pet may be penalized for triggering a sensor at an incorrect time. Such penalty may not be a punishment for the pet but may delay an opportunity to move forward to Pet Receives Reward 240, for example. At Pet Performs Tasks 220, the absence of detecting a sensor event when one is expected may have an impact on the task that is waiting to be performed. Regarding Pet Completes Tasks 230, the progression through tasks may not be linear. There may be a plurality of tasks that a pet may perform, and the system may reward the pet for performing any of the potentially correct tasks.

Humans may have the ability to kick off Game Play Initiated 210. At Human Receives Notifications 215, a human may receive notifications about a pet's progress through SMS messages, email, photos, video clips, or other multimedia formats, for example. At Human Watches Game Play Remotely 225, humans may view still, video, statistics, and other data, as well as hear sounds from the pet's game play, remotely through a computer or mobile device, for example. Multiple humans may simultaneously participate in Human Watches Game Play Remotely 225. Humans may also interact during Human Watches Game Play Remotely 225; for example, they may engage in direct messaging. Human Watches Game Play Remotely 225 may not be dependent on Human Receives Notifications 215. For example, a human may just open an app and watch a live feed or recorded video without first being notified. At Pet Data Shared on Social Media 235, humans may share data through social media, SMS messages, email, or other channels, or data may be automatically shared by Adaptive Learning System for Animals 100 through any channels available.

Adaptive Learning System for Animals 100 may also be used by multiple pets. Moreover, multiple humans may simultaneously experience the steps Human Receives Notifications 215, Human Watches Game Play Remotely 225, and Pet Data Shared on Social Media 235. Also, humans may be able to partake in other software features such as donating to shelters and adopting pets, for example.

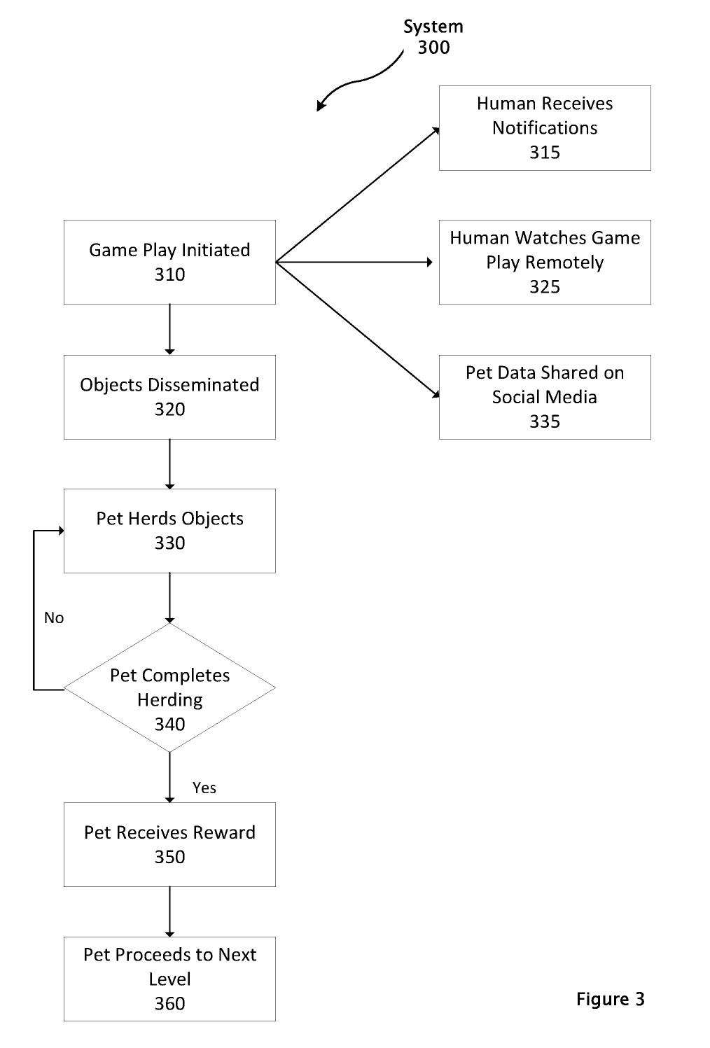

FIG. 3 illustrates a flow diagram 300 of an Adaptive Learning System for Animals herding game process, according to one embodiment. In this example, a herding game may require a pet to herd a plurality of objects. At Game Play Initiated 310, a pet may initiate game play by performing an action such as pressing a button, picking up a toy, or triggering a motion sensor or visual detection sensor, for example. Game play may also be initiated automatically based on time or a system event, or it may be initiated remotely, for example, by a human using a computer user interface, browser or mobile application. At Objects Disseminated 320, a plurality of objects such as pet toys, for example, may either be dispensed and arranged onto a surface by the Adaptive Learning System for Animals 100, or the objects may be provided and arranged manually by a human or pet, for example. At Pet Herds Objects 330, a pet may be prompted to lead the objects to a particular location or into a particular formation, for example. At Pet Completes Herding 340, the pet may receive a reward for finishing the required herding actions. At Pet Receives Reward 350, the reward in the herding game may comprise a pet's satisfaction in successfully herding the objects rather than a treat from a treat dispenser, for example. The pet may also be rewarded simply by the act of herding, and further rewards, such as a treat from the treat dispenser, may not be required. The herding game may be a long engagement game, requiring hours of a pet's continuous attention. At Pet Proceeds to Next Level 360, the pet's completion of herding actions may allow it to move onto another level.

In one embodiment, an Adaptive Learning System for Animals herding game may use technology to detect spatial relations between objects. Objects may talk to one another, and their relative positions may be mapped on a mesh network, for example. In another embodiment, a camera in the gaming console may track the objects using infrared or heat detection, for example. In yet another embodiment, a camera in the gaming console may process a particular signal from the objects. In yet another embodiment, a combination of technologies may track the spatial relationship of the objects.

Objects may be configured to wander both away from the herd and in a direction encouraged by a pet. A pet may push or roll the objects, and the pet's location may or may not encourage objects to move in a certain direction. The objects may also have a hierarchy; for example, a lead object may influence the other objects. A pet's ability to determine which object is the leader may impact the behavior of the other objects. Characteristics of an animal herd such as sheep, aligned with a herding animal's natural instinct, may be imitated.

The herding game may become increasingly complex as more objects are added or as the objects become less cooperative and require more aggressive herding or more frequent attention, for example. The behavior of the herd might also evolve to be more complex, with a more complex hierarchy which may make the herd's behavior more complex, such as subgroups that follow different leader objects, for example.

In yet another embodiment, objects in a herding game, such as pet toys, may be aware of one another, such as of their respective location or state. A game might also involve coordination between multiple toys.

At Human Receives Notifications 315, a human may receive notifications about a pet's progress in the herding game through various multimedia formats. At Human Watches Game Play Remotely 325, multiple humans may remotely and simultaneously view still, video, statistics, and other data and sounds from the pet's game play. Humans may also interact during Human Watches Game Play Remotely 325; for example, they may engage in direct messaging. At Pet Data Shared on Social Media 335, humans may share data through social media, SMS messages, email, or other channels, or data may be automatically shared by Adaptive Learning System for Animals 100 through any channels available.

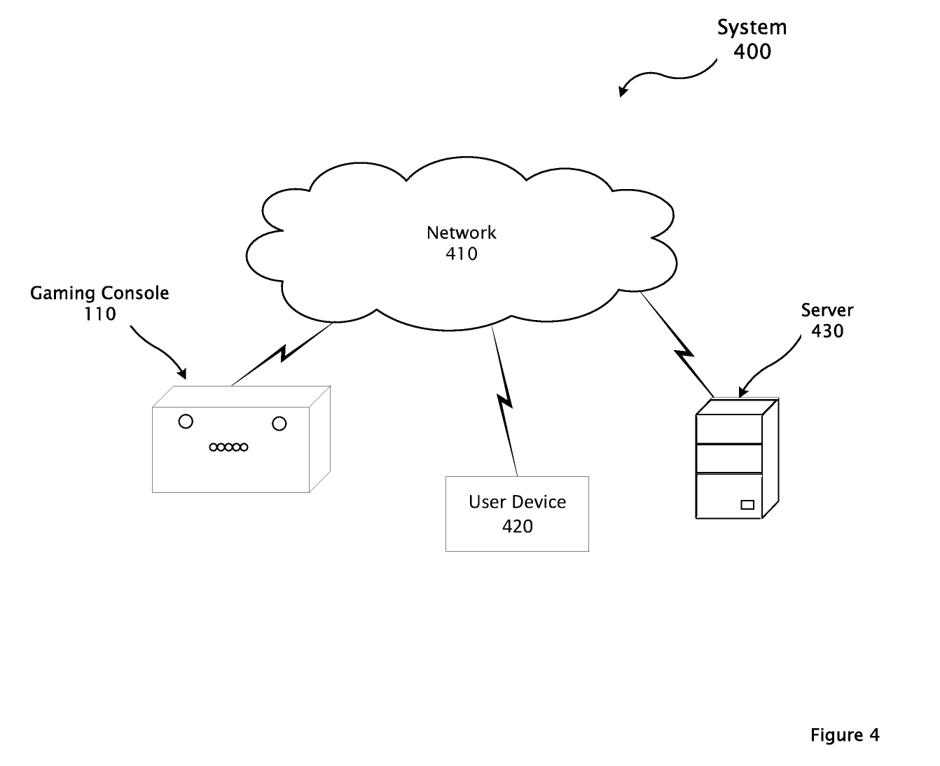

FIG. 4 is a block diagram illustrating an example of a system 400 capable of supporting an Adaptive Learning System for Animals process, according to one embodiment. Network 410 may include Wi-Fi, cellular data access methods, such as 3G or 4GLTE, BLUETOOTH®, Near Field Communications (NFC), the internet, local area networks, wide area networks, or any combination of these or other means of providing data transfer capabilities. In one embodiment, Network 410 may comprise Ethernet connectivity. In another embodiment, Network 410 may comprise fiber optic connections.

User Device 420 may be a smartphone, tablet, desktop computer, laptop computer, smart watch or intelligent eyewear, or other device, and may have network capabilities to communicate with Server 430. Server 430 may include one or more computers, and may serve a number of roles. Server 430 may be conventionally constructed or may be of a special purpose design for processing data obtained from Adaptive Learning System for Animals 100. One skilled in the art will recognize that Server 430 may be of many different designs and may have different capabilities.

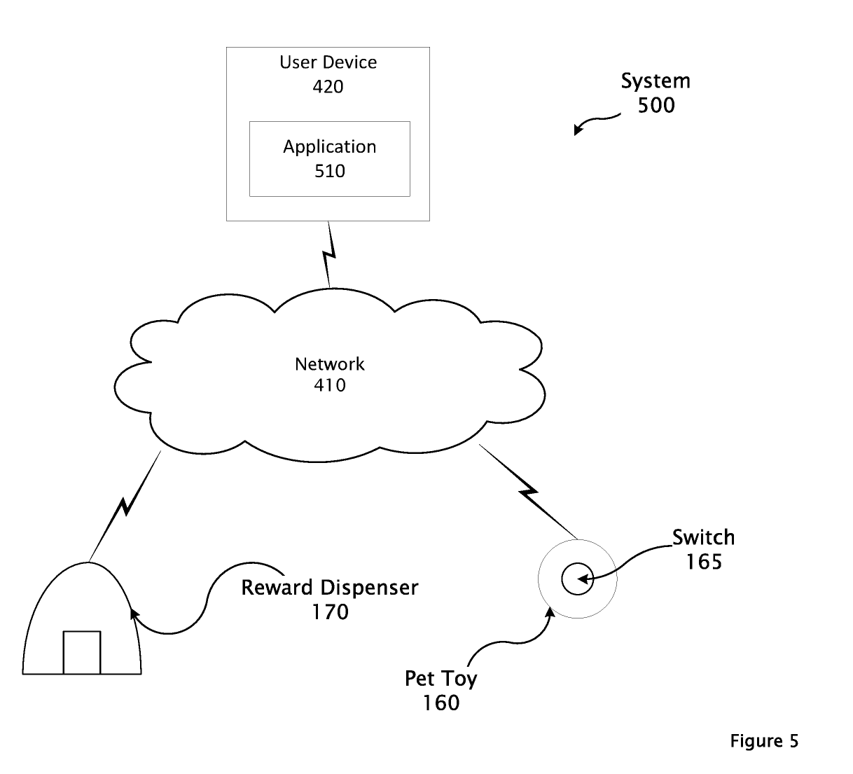

FIG. 5 illustrates Adaptive Learning System for Animals 500, according to another embodiment. In this example, Pet Toy 160 may be connected or controlled by a User Device 420. For example, User Device 420 may access and display mobile applications, such as Application 510, on the User Device. User Device 420 may access and enable Application 510 through one or more application stores, for example, Google™ Play Store, iTunes®, Apple™ App Store, Blackberry™ AppWorld, Windows Store, or the like. Application 510 may communicate with one or more devices (e.g., Reward Dispenser 170 and Pet Toy 160) over Network 410. Application 510 may connect User Device 420 to Adaptive Learning System for Animals 500 and provide the User Device 420 functionality similar to that performed by Gaming Console 110. For example, Application 510 may permit a user to initiate game play for Adaptive Learning System for Animals 500 via User Device 420. Initiation of game play may permit the user to select a task level to be performed by the pet and communicate the selected task level to the Pet Toy 160 or the Reward Dispenser 170. More specifically, Adaptive Learning System for Animals 500 may be comprised of multiple task levels from which to communicate to the Pet Toy 160 or the Reward Dispenser 170. Each task level may correspond to a specific degree of difficulty associated with a skill a pet must perform prior to receiving a reward. In one example, task level 1 may correspond to a less difficult task than a task level 5. It is, however, to be appreciated by those of skilled in the art that any task level designation may be used to correspond to a degree of difficulty.

Furthermore, notification as to a pet's progress (i.e., succeeding at a task or struggling at a task) may be communicated to the User Device 420 via Application 510. Upon receipt of a pet's progress, the user may adjust the level of difficulty accordingly. For example, upon notification to a user that a pet is struggling to complete a task at a task level 4, the user may elect to adjust Adaptive Learning System for Animals 500 to a lower task level (i.e., easier, less difficult), for example, a task level 2.

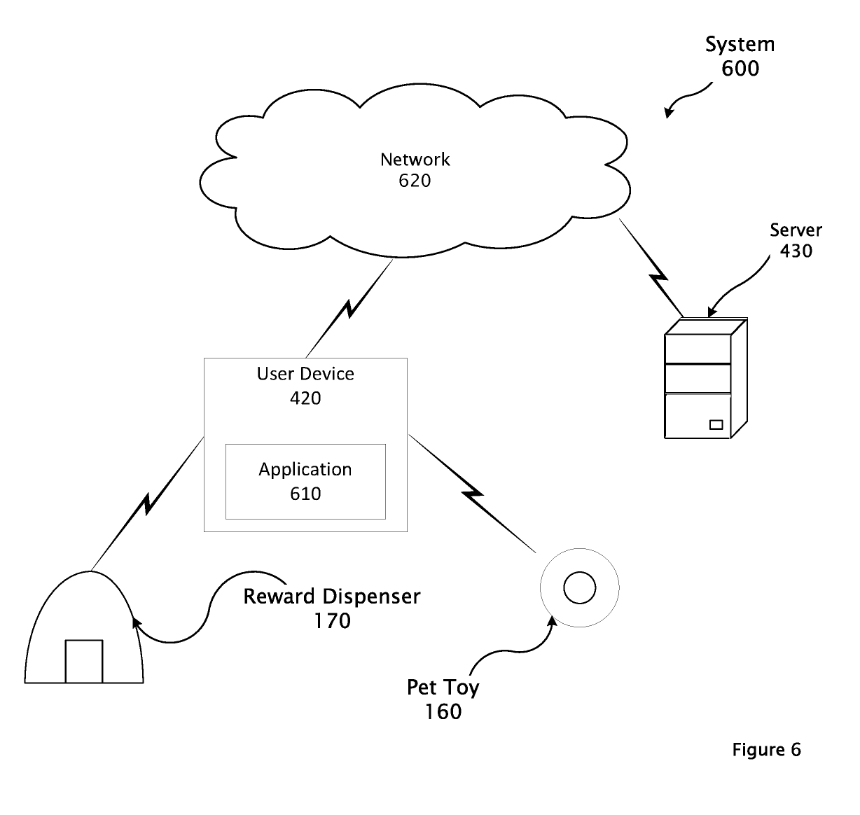

FIG. 6 illustrates Adaptive Learning System for Animals 600, according to another embodiment. In this example, Pet Toy 160 and Reward Dispenser 170 may be controlled by User Device 420. For example, User Device 420 may access and display mobile applications, such as Application 610, on the User Device. User Device 420 may access and enable Application 610 through one or more application stores, for example, Google™ Play Store, iTunes®, Apple™ App Store, Blackberry™ AppWorld, Windows Store, or the like. Application 610 may communicate with one or more devices (e.g., Reward Dispenser 170 and Pet Toy 160) over Network 620. Network 620 may include Wi-Fi, cellular data access methods, such as 3G or 4GLTE, BLUETOOTH®, Near Field Communications (NFC), the internet, local area networks, wide area networks, or any combination of these or other means of providing data transfer capabilities. In one embodiment, Network 410 may comprise Ethernet connectivity. In another embodiment, Network 410 may comprise fiber optic connections.

User Device 420 may act as a BLUETOOTH® master, while Reward Dispenser 170 and Pet Toy 160 may act as BLUETOOTH® Slaves, for example. User Device 420 may also communicate with Server 430, which may provide extra functionality for Application 610, including storage of data or software routines.

Furthermore, notification as to a pet's progress (i.e., succeeding at a task or struggling at a task) may be communicated to the User Device 420 via Application 610. Upon receipt of a pet's progress, the user may adjust the level of difficulty accordingly. For example, upon notification to a user that a pet is struggling to complete a task at a task level 4, the user may elect to adjust Adaptive Learning System for Animals 600 to a lower task level (i.e., easier, less difficult), for example, a task level 2. Successful completion of a task reported by Pet Toy 160 may be reported to User Device 420, which may send a command to Reward Dispenser 170 to dispense a treat, for example.

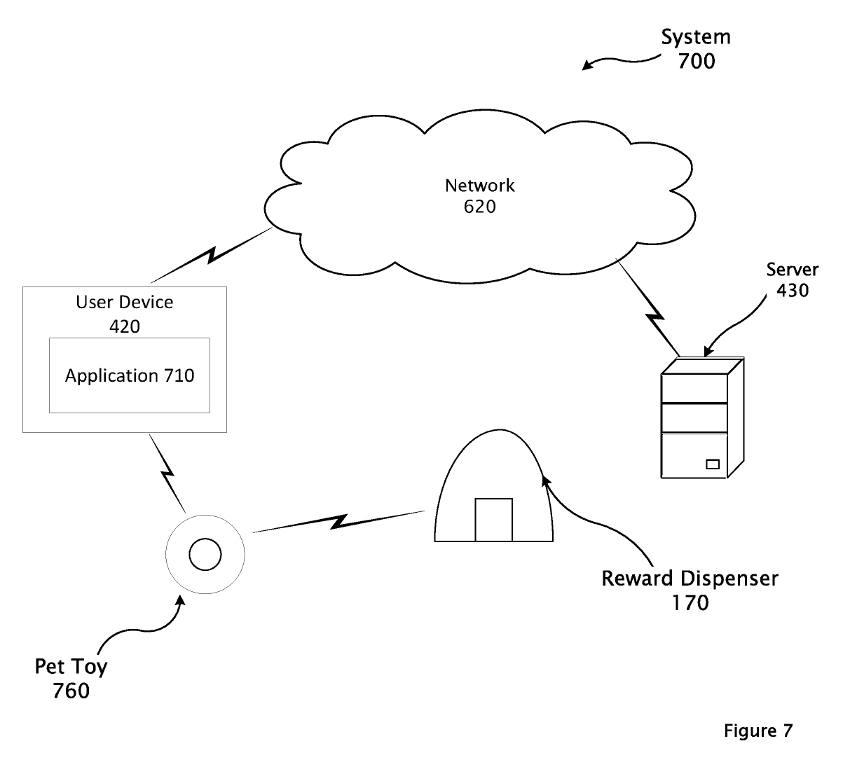

FIG. 7 illustrates Adaptive Learning System for Animals 700, according to another embodiment. In this example, Pet Toy 160 and Reward Dispenser 170 may be controlled by User Device 420. For example, User Device 420 may access and display mobile applications, such as Application 710, on the User Device. User Device 420 may access and enable Application 710 through one or more application stores, for example, Google™ Play Store, iTunes®, Apple™ App Store, Blackberry™ AppWorld, Windows Store, or the like. Application 710 may communicate with one or more devices (e.g., Reward Dispenser 170 and Pet Toy 160) over Network 620. User Device 420 and Pet Toy 160 may act as BLUETOOTH® masters, while Reward Dispenser 170 may act as a BLUETOOTH® Slave, for example. User Device 420 may also communicate with Server 430, which may provide extra functionality for Application 710, including storage of data or software routines.

Furthermore, notification as to a pet's progress (i.e., succeeding at a task or struggling at a task) may be communicated from Pet Toy 760 to the User Device 420 via Application 710. Upon receipt of a pet's progress, the user may adjust the level of difficulty accordingly. For example, upon notification to a user that a pet is struggling to complete a task at a task level 4, the user may elect to adjust Adaptive Learning System for Animals 600 to a lower task level (i.e., easier, less difficult), for example, a task level 2. Successful completion of a task reported by Pet Toy 160 may be reported to User Device 420. Pet Toy 760 may also send a command to Reward Dispenser 170 to dispense a treat.

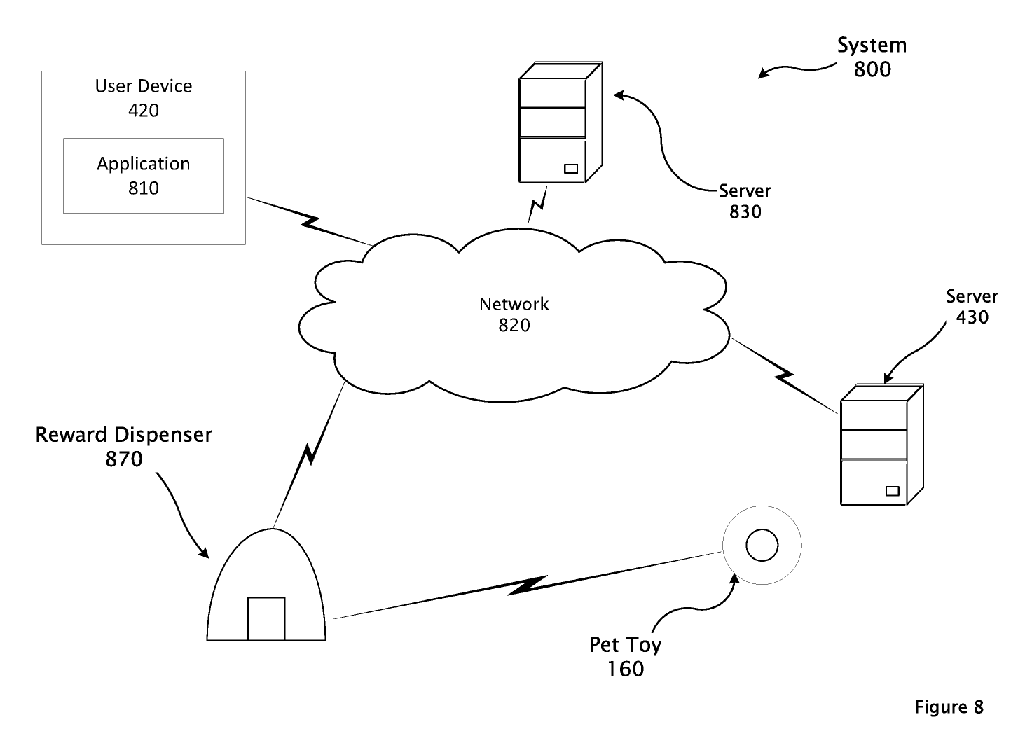

FIG. 8 illustrates Adaptive Learning System for Animals 800, according to another embodiment. In this example, User Device 420 may access and display mobile applications, such as Application 810, on the User Device. User Device 420 may access and enable Application 810 through one or more application stores, for example, Google™ Play Store, iTunes®, Apple™ App Store, Blackberry™ AppWorld, Windows Store, or the like. Application 810 may communicate with Reward Dispenser 170 over Network 820.

Network 820 may include Wi-Fi, cellular data access methods, such as 3G or 4GLTE, BLUETOOTH®, Near Field Communications (NFC), the internet, local area networks, wide area networks, or any combination of these or other means of providing data transfer capabilities. In one embodiment, Network 410 may comprise Ethernet connectivity. In another embodiment, Network 410 may comprise fiber optic connections.

Application 810 may connect User Device 420 to Adaptive Learning System for Animals 800. For example, Application 810 may permit a user to initiate game play for Adaptive Learning System for Animals 800 via User Device 420. Initiation of game play may permit the user to select a task level to be performed by the pet and communicate the selected task level to Reward Dispenser 170. Reward Dispenser 170 may communicate with Pet Toy 160, sending game control messages and receiving dispense commands, for example.

Furthermore, notification as to a pet's progress (i.e., succeeding at a task or struggling at a task) may be communicated to the User Device 420 via Application 510. Upon receipt of a pet's progress, the user may adjust the level of difficulty accordingly. For example, upon notification to a user that a pet is struggling to complete a task at a task level 4, the user may elect to adjust Adaptive Learning System for Animals 500 to a lower task level (i.e., easier, less difficult), for example, a task level 2.

User Device 420 may also communicate with Server 430, which may provide extra functionality for Application 810, including storage of data or software routines. Reward Dispenser 870 may communicate with Server 430, to receive game control messages from Application 810, and may communicate with Server 830, which may, for example, store data or configuration information about Reward Dispenser 870.

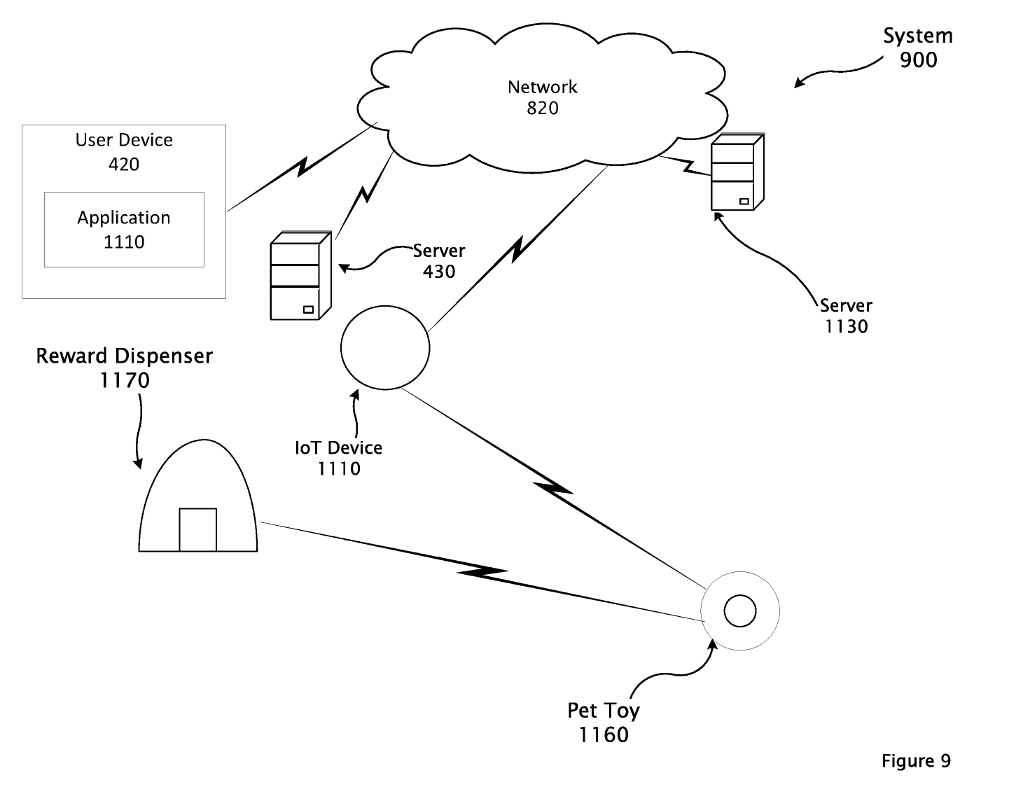

FIG. 9 illustrates Adaptive Learning System for Animals 1100, according to another embodiment. In this example, User Device 420 may access and display mobile applications, such as Application 1110, on the User Device. User Device 420 may access and enable Application 1110 through one or more application stores, for example, Google™ Play Store, iTunes®, Apple™ App Store, Blackberry™ AppWorld, Windows Store, or the like. Application 1110 may communicate with Server 430 over Network 1120, sending game results, for example. Server 430 may communicate with Server 1130, sending game results, other data, or configuration information. Server 1130 may store or process the received data and communicate with Internet of Things (IoT) device 1110, which may, for example, be a smart speaker. IoT Device 1110 may further communicate with Pet Toy 1160, using BLUETOOTH®, for example, sending settings or other data to Pet Toy 1160, and receiving results or other data from Pet Toy 1160. Pet Toy 1160 may send Reward Dispenser 1170 dispense commands using BLUETOOTH®, for example. One having skill in the art will recognize that devices may use various ways to communicate.

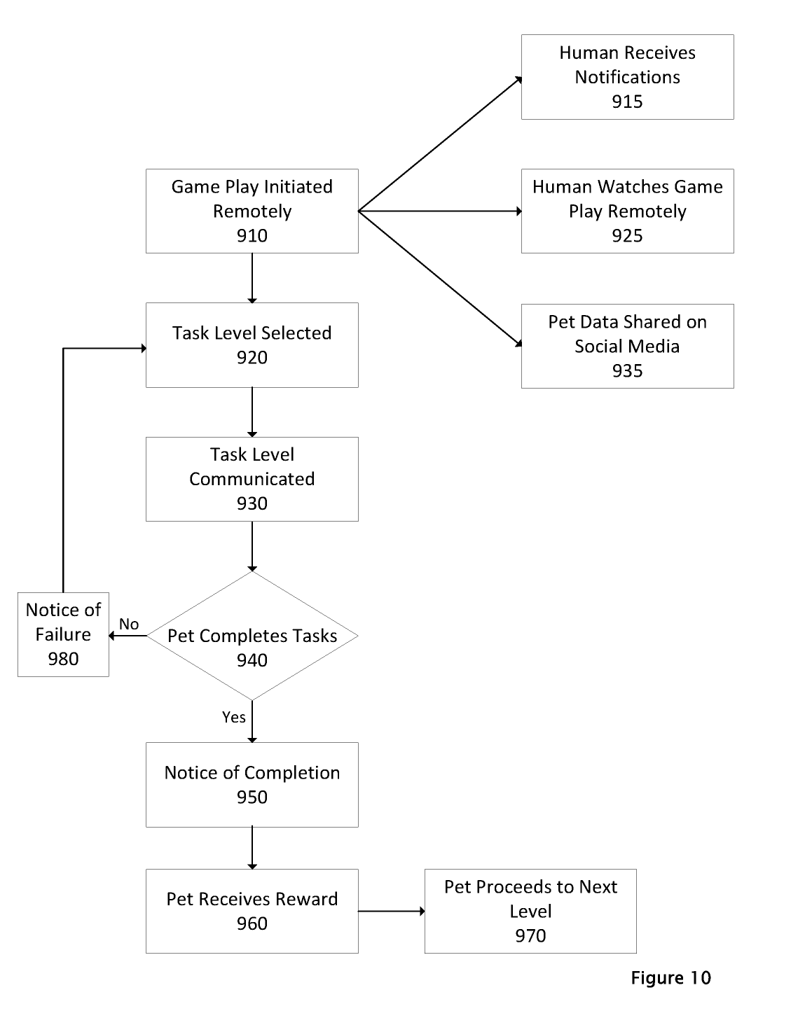

FIG. 10 illustrates a flow diagram of Adaptive Learning System for Animals 500, according to another embodiment. In one example implementation, Reward Dispenser 170 may dispense a reward when the Reward Dispenser receives notification from Pet Toy 160, User Device 420, or the like, that one or more game conditions have been met. For example, at Game Play initiated 910, a human may initiate game play remotely using a computer user interface, browser, or mobile application. At Task Level Selected 920, the human may select a task level from one or more task levels. Alternatively, or additionally, the task level may be automatically selected by Adaptive Learning System for Animals 500. In one example, the task level(s) may correspond to a degree of difficulty associated with one or more tasks the pet must complete to receive a reward in Adaptive Learning System for Animals 500.

At Task Level Communicated to 930, the task level may be communicated from the User Device 420 to Pet Toy 160 or Reward Dispenser 170. At Pet Completes Tasks 940, the pet may progress through game levels based on completion of various tasks. If Pet Completes Tasks 940, Notification of Completion 950 may be communicated to Rewards Dispenser 170. At Pet Receives a Reward 960, Reward Dispenser 170 may dispense a reward.

At any stage during an Adaptive Learning System for Animals process, a human may send commands to Adaptive Learning System for Animals 500 to influence which task the pet has to complete. For example, at Pet Proceeds to Next Level 970, a user may communicate a task level selection remotely using a computer user interface, browser, or mobile application, for example, Application 510. Alternatively or additionally, Adaptive Learning System for Animals 500 may automatically select a subsequent task level. At Pet Proceeds to Next Level 970, the pet may begin a new level, which may include more advanced or challenging tasks, or simply a different task which is not necessarily more challenging, for example. The pet may receive additional rewards for completing a level, or it may receive rewards only upon completing all levels in a game, for example.

If at Pet Completes Tasks 940 the pet fails to satisfactorily complete a task level, a Notice of Failure 980 may be communicated to User Device 420 via Application 510, and the pet may be redirected, either automatically or by a human remotely using a computer user interface, browser, or mobile application (i.e., Application 510), back to Task Level Selection 920. The pet may be directed to a previous level if it fails to complete certain tasks if Adaptive Learning System for Animals system or a user of User Device 420 has determined that a pet is struggling at a task or level, for example. A pet may also be directed to jump or skip to higher levels.

At Human Receives Notifications 915, the human may receive notifications about a pet's progress through SMS messages, email, photos, video clips, or other multimedia formats, for example. At Human Watches Game Play Remotely 925, humans may view still, video, statistics, and other data, as well as hear sounds from the pet's game play, remotely through a computer or mobile device, for example. Multiple humans may simultaneously participate in Human Watches Game Play Remotely 925. Humans may also interact during Human Watches Game Play Remotely 925; for example, they may engage in direct messaging. Human Watches Game Play Remotely 925 may not be dependent on Human Receives Notifications 915. For example, a human may just open an app and watch a live feed or recorded video without first being notified. At Pet Data Shared on Social Media 935, humans may share data through social media, SMS messages, email, or other channels, or data may be automatically shared by Adaptive Learning System for Animals 500 through any channels available.

Adaptive Learning System for Animals 500 may also be used by multiple pets. Moreover, multiple humans may simultaneously experience the steps Human Receives Notifications 915, Human Watches Game Play Remotely 925, and Pet Data Shared on Social Media 930. Also, humans may be able to partake in other software features such as donating to shelters and adopting pets, for example.

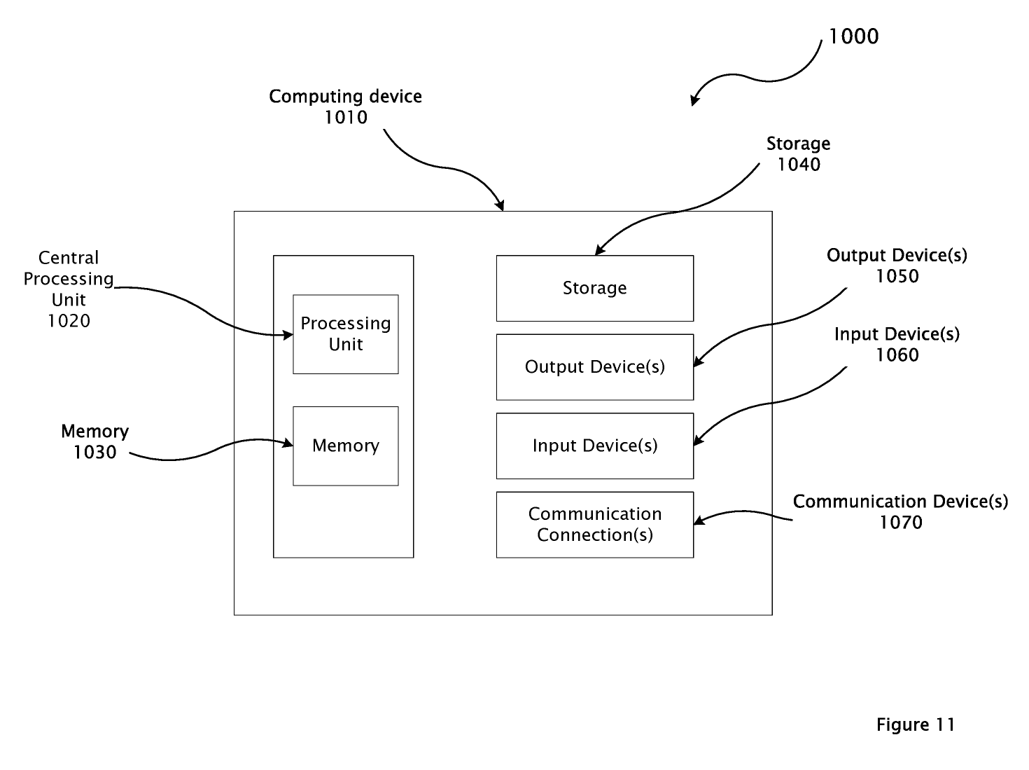

FIG. 11 is a component diagram of a computing device to which an Adaptive Learning System for Animals process may be applied according to one embodiment. The Computing Device 1010 can be utilized to implement one or more computing devices, computer processes, or software modules described herein, including, for example, but not limited to a mobile device. In one example, the Computing Device 1010 can be used to process calculations, execute instructions, and receive and transmit digital signals. In another example, the Computing Device 1010 can be utilized to process calculations, execute instructions, receive and transmit digital signals, receive and transmit search queries and hypertext, and compile computer code suitable for a mobile device. The Computing Device 1010 can be any general or special purpose computer now known or to become known capable of performing the steps or performing the functions described herein, either in software, hardware, firmware, or a combination thereof.

In its most basic configuration, Computing Device 1010 typically includes at least one Central Processing Unit (CPU) 1020 and Memory 1030. Depending on the exact configuration and type of Computing Device 1010, Memory 1030 may be volatile (such as RAM), non-volatile (such as ROM, flash memory, etc.) or some combination of the two. Additionally, Computing Device 1010 may also have additional features/functionality. For example, Computing Device 1010 may include multiple CPUs. The described methods may be executed in any manner by any processing unit in Computing Device 1010. For example, the described process may be executed by both multiple CPUs in parallel.

Computing Device 1010 may also include additional storage (removable or non-removable) including, but not limited to, magnetic or optical disks or tape. Such additional storage is illustrated in FIG. 4 by Storage 1040. Computer readable storage media include volatile and nonvolatile, removable and non-removable media implemented in any method or technology for storage of information such as computer-readable instructions, data structures, program modules or other data. Memory 1030 and Storage 1040 are all examples of computer-readable storage media. Computer readable storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information, and which can access by Computing Device 1010. Any such computer-readable storage media may be part of Computing Device 1010. But computer-readable storage media do not include transient signals.

Computing Device 1010 may also contain Communications Device(s) 1070 that allow the device to communicate with other devices. Communications Device(s) 1070 is an example of communication media. Communication media typically embody computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media include wired media such as a wired network or direct-wired connection, and wireless media such as acoustic, radio frequency (RF), infrared and other wireless media. The term computer-readable media as used herein includes both computer-readable storage media and communication media. The described methods may be encoded in any computer-readable media in any form, such as data, computer-executable instructions, and the like.

Computing Device 1010 may also have Input Device(s) 1060 such as a keyboard, a mouse, a pen, a voice input device, a touch input device, etc. Output Device(s) 1050 such as a display, speakers, printer, etc. may also be included. All these devices are well known in the art and need not be discussed at length.

Those skilled in the art will realize that storage devices utilized to store program instructions can be distributed across a network. For example, a remote computer may store an example of the process described as software. A local or terminal computer may access the remote computer and download a part or all of the software to run the program. Alternatively, the local computer may download pieces of the software as needed, or execute some software instructions at the local terminal and some at the remote computer (or computer network). Those skilled in the art will also realize that by utilizing conventional techniques known to those skilled in the art that all, or a portion of the software instructions, may be carried out by a dedicated circuit, such as a digital signal processor (DSP), programmable logic array, or the like.

While the detailed description above has been expressed in terms of specific examples, those skilled in the art will appreciate that many other configurations could be used. Accordingly, it will be appreciated that various equivalent modifications of the above-described embodiments may be made without departing from the spirit and scope of the distant disclosure.

Additionally, the illustrated operations in the description show certain events occurring in a certain order. In alternative embodiments, certain operations may be performed in a different order, modified or removed. Moreover, steps may be added to the above-described logic and still conform to the described embodiments. Further, operations described herein may occur sequentially, or certain operations may be processed in parallel. Yet further, operations may be performed by a single processing unit or by distributed processing units.

The foregoing description of various embodiments of the invention has been presented for the purposes of illustration and description. It is not intended to be exhaustive or to limit the invention to the precise form disclosed. It is intended that the scope of the invention be limited not by this detailed description, but rather by the claims appended hereto. The above specification, examples, and data provide a complete description of the manufacture and use of the invention. Since many embodiments of the invention can be made without departing from the spirit and scope of the invention, the invention resides in the claims hereinafter appended.

1. An adaptive learning system for pets, comprising:
a mobile user device comprising one or more game play applications;
a pet toy, wherein the pet toy comprising a sensor;
a reward dispenser; and
an interface, wherein the interface connects the one or more game play applications to the pet toy or the reward dispenser.

2. The adaptive learning system for pets of claim 1, wherein the one or more game play applications are utilized to initiate one or more game play modes, each game play mode comprising one or more task levels.

3. The adaptive learning system for pets of claim 2, wherein a completion of a task level is communicated from the pet toy or the reward dispenser to the mobile user device via the one or more game play applications.

4. The adaptive learning system for pets of claim 2, wherein a failure to complete a task level is communicated from the pet toy or the reward dispenser to the mobile user device via the one or more game play applications.

5. The adaptive learning system for pets of claim 2, wherein the one or more task levels comprise a level of difficulty corresponding to a task that is to be completed by a pet.

6. The adaptive learning system for pets of claim 5, wherein the one or more task levels are adjusted using the one or more game play applications.

7. The adaptive learning system for pets of claim 1, wherein the interface comprises at least one of a low energy interface, a Wi-Fi interface, or a radio frequency interface.

8. A method for an adaptive learning system for animals, comprising:
accessing one or more game play applications on a mobile user device;
accessing an interface;
initiating, by one or more game play applications, a game play mode;
performing a task related to a level;
communicating a notification of completion of the task from a pet toy or a reward dispenser to the mobile user device;
receiving a reward; and
changing, using the one or more game play applications, to a different level after successful completion of the task.

9. The method of claim 8 further comprising:
communicating, via the one or more game play applications, a failure to complete the task; and
adjusting, via the one or more game play applications, the level according to the failure to complete the task.

10. The method of claim 8, wherein the pet toy is activated by the one or more game play applications.

11. The method of claim 8, wherein the interface comprises at least one of a low energy interface, a Wi-Fi interface, or a radio frequency interface.

12. Computer-readable storage media containing instructions thereon which, when executed by a processor, perform a method comprising:
accessing one or more game play applications on a mobile user device;
accessing an interface;
initiating, by one or more game play applications, a game play mode;
performing a first task related to a level;
communicating a notification of completion of the first task from a pet toy or a reward dispenser to the mobile user device;
receiving a reward; and
being redirected, by the one or more game play applications, to a second task upon successful completion of the first task.

13. The computer-readable storage media of claim 12 wherein the method further comprises:
communicating, via the one or more game play applications, a failure to complete the first task; and
adjusting, via the one or more game play applications, the level according to the failure to complete the first task.

14. The computer-readable storage media of claim 12, wherein the pet toy is activated by the one or more game play applications.

15. The computer-readable storage media of claim 12, wherein the interface comprises at least one of a low energy interface, a Wi-Fi interface, or a radio frequency interface.
